(19) United States
(12) Patent Application Publication
(10) Pub. No.: US 2008/0226535 A1
(43) Pub. Date: Sep. 18, 2008

(54) Method and Apparatus for Manufacturing Carbon Nano Tube

(75) Inventors: Chul Park, Daejeon (KR); Keun-Shik Chang, Daejeon (KR)

Correspondence Address: KNOBBE MARTENS OLSON & BEAR LLP, 2040 MAIN STREET, FOURTEENTH FLOOR, IRVINE, CA, 92614, US

(73) Assignee: Korea Advanced Institute of Science and Technology, Daejeon (KR)

(21) Appl. No.: 11/597,395

(22) PCT Filed: May 19, 2005
(86) PCT No.: PCT/KR05/01469

§ 371 Date: Dec. 27, 2007

(30) Foreign Application Priority Data
May 20, 2004 (KR) 10-2004-0035931

(51) Int. Cl. B82B 3/00; C01B 31/00; B01J 19/00; B06B 1/00

(52) U.S. Cl. 423/447.3; 422/187; 422/127; 977/742

(57) ABSTRACT

The present invention relates to a method and apparatus for manufacturing a carbon nano tube, and more particularly, to a method and apparatus for manufacturing a carbon nano tube by which a carbon nano tube having a uniform property and high purity can be manufactured by uniformly raising a temperature of reaction gas, which includes a gaseous transition metal catalyst precursor compound and gaseous carbon compound contained in a hermetically closed reaction space, to the Boudouard reaction temperature. The method for manufacturing a carbon nano tube according to the present invention comprises the steps of preparing a reaction vessel including a substantially hermetic and compressible reaction space; supplying the reaction space with carbon nano tube reaction gas containing a gaseous carbon compound and a gaseous transition metal catalyst precursor compound; and compressing the reaction gas in the reaction space until a temperature of the carbon nano tube reaction gas supplied to the reaction space reaches a temperature equal to or greater than a minimum starting temperature of the Boudouard reaction and a temperature at which the transition metal catalyst precursor compound is thermally decomposed, thereby producing gas with carbon nano tube products suspended therein.

### TECHNICAL FIELD

The present invention relates to a method and apparatus for manufacturing a carbon nano tube, and more particularly, to a method and apparatus for manufacturing a carbon nano tube by which a carbon nano tube having a uniform property and high purity can be manufactured by uniformly raising a temperature of reaction gas, which includes a gaseous transition metal catalyst precursor compound and gaseous carbon compound contained in a hermetically closed reaction space, to the Boudouard reaction temperature.

### BACKGROUND ART

In general, a carbon nano tube (CNT) is one of the four known forms of solid carbon, the other three being diamond, C₆₀, and graphite, and is in a tabular form. CNTs have many properties that can potentially be exploited for various worthwhile purposes.

The general principle of CNT formation is well known in the art. In general, CNT is produced when carbon-bearing gas molecules such as carbon monoxide (CO) collide against a surface of a metal catalyst such as iron (Fe) at an elevated temperature. In order for the produced CNTs to have uniform characteristics (i.e., diameter, length, and molecular structure, etc), the size of catalyst should be uniform and the temperature and pressure of the carbon-bearing gas should be spatially uniform. Further, in order to produce CNTs in a large quantity, the number of metal catalysts per unit volume should be large and the frequency of collision of the carbon-bearing molecules with the metal catalysts should be high. A condition suitable for mass production of CNTs can be found through a variety of test performed while changing the temperature and pressure.

A vapor phase growth method using a catalyst among the methods of manufacturing carbon nano tubes is composed of two mechanisms, i.e. a process of producing a metal catalyst and a process of producing a carbon nano tube. The metal catalyst can be obtained by thermally decompose metal-bearing gas such as Fe(CO)₅ at high pressure. When the metal-bearing gas such as Fe(CO)₅ is heated, it is dissociated to generate a metal atom such as Fe, as expressed in the following formula (I). The dissociated metal atoms are combined together to form a large spherical body composed of several hundreds of metal atoms, which is referred to as a cluster, as expressed in the following formula (II).

Fe(CO)₅→Fe+5CO (I)

nFe→Feₙ, where 10<n<1000 (II)

Then, the carbon-bearing gas such as carbon monoxide (CO) is brought into contact with the produced metal cluster at a high temperature. At this time, as shown in FIG. 1, a carbon nano tube 2 grows by means of disproportionation reaction of the carbon monoxide 3 colliding against a surface of a metal catalyst 1. The disproportionation reaction of the carbon monoxide (CO) is referred to as a Boudouard reaction. The reaction in which the carbon nano tube is produced on the iron catalyst 1 is made as in the formula (III), and a temperature at which such reaction starts is referred to as a starting temperature of the Boudouard reaction.

CO+Feₙ→CNT+½O₂+Feₙ (III)

The mass production of the carbon nano tube that succeeded for the first time is a HiPco process (High Pressure carbon monoxide process) developed by Bronikowski et al. using such an apparatus as schematically shown in FIG. 2 [Bronikowski M J, Willis P A, Colbert D T, Smith K A, and Smalley R E (2001) Gas phase production of carbon single-walled nanotubes from carbon monoxide via the HiPco process: A parametric study. J. Vac. Sc. Technol. A 19: 1800-1805]. The metal-bearing gas used in this process is an iron pentacarbonyl (Fe(CO)₅), and the carbon-bearing gas is a carbon monoxide (CO). The chemical reaction occurring in the HiPco process as expressed in the formula (I)-(III) was already analyzed by Gokcen and Dateo [Gokcen T and Dateo CE (2000), Modeling of HiPco process for carbon nanotube production, Reactor-scale analysis. J. Nanose. And Nanotechn. 2: 523-534].

### DISCLOSURE OF INVENTION

When CNTs produced through the aforementioned process is used, it is preferred that CNTs have uniform properties, i.e. uniform diameter, length and molecular structure. To manufacture CNTs having a uniform property, metal catalysts must have a uniform diameter. As it can be understood from FIG. 1, the diameter of the carbon nano tube growing on a surface of a metal cluster is generally proportional to that of the cluster. To manufacture CNTs having a uniform diameter, therefore, metal catalysts must have a uniform diameter. In order for the metal clusters to have a uniform diameter, the reactions as expressed in the formula (I) and (II) must occur at a constant rate regardless of reaction regions. That is, the reaction rate should be spatially uniform.

The reaction rate in the formula (I) and (II) is a function of a reaction temperature and a concentration of gas species participating in the reaction. In the conventional process of manufacturing a carbon nano tube such as the HiPco process, the reaction gas is heated and cooled by heating and cooling a wall of a reactor. That is, when the heating or cooling is performed, heat is conducted through the reactor wall and reaction gas. At this time, since a heat conduction rate is proportional to a temperature gradient, the heat can be transferred to the reaction gas only if there is a temperature gradient in the gas. This means that the temperature of the reaction gas is not spatially uniform. According to the analysis of Gokcen and Dateo, the temperature of the reaction gas in the reactor varies between 300 K to 1300 K in the HiPco process.

As described above, since the process of manufacturing a carbon nano tube according to a method for heating reaction gas through heat transfer due to the temperature gradient, such as the HiPco process, is premised on inevitable non-uniformity of the reaction gas temperature, non-uniform metal catalyst is produced due to the non-uniform temperature distribution in the reactor. There is a limitation on the manufacture of a carbon nano tube having a uniform property.

An object of the present invention is to provide a method for manufacturing a carbon nano tube having a uniform property and high purity by spatially uniformly raising the temperature of the reaction gas comprising gaseous carbon compound and gaseous transition metal catalyst precursor compound.

Another object of the present invention is to provide an apparatus capable of manufacturing a carbon nano tube having a uniform property and high purity using the aforementioned manufacturing method.

A further object of the present invention is to provide a carbon nano tube which has a uniform property and high purity and is manufactured by the aforementioned manufacturing method.

By “adiabatic” used herein is meant that reaction gas is not intentionally heated or cooled using a heat source when the reaction gas is compressed or expanded. That is, the word “adiabatic” used herein has a different meaning from the conventional meaning of adiabatic that natural heat transfer to the surroundings through a reaction vessel is intentionally completely prevented, and actually has such a meaning that medium of consideration is not intentionally heated or cooled using a heat source (i.e., there is no heat transfer to the medium of consideration).

According to an aspect of the present invention, there is provided a method for manufacturing a carbon nano tube, comprising the steps of preparing a reaction vessel including a substantially hermetic and compressible reaction space; supplying the reaction space with carbon nano tube reaction gas containing a gaseous carbon compound and a gaseous transition metal catalyst precursor compound; and producing suspension gas with carbon nano tube products suspended therein by compressing the reaction gas in the reaction space until a temperature of the carbon nano tube reaction gas supplied to the reaction space reaches a temperature equal to or greater than a temperature at which the transition metal catalyst precursor compound is thermally decomposed and a minimum starting temperature of the Boudouard reaction. In addition, the method for manufacturing a carbon nano tube according to the present invention may further comprise the step of preheating the carbon nano tube reaction gas at a temperature below the thermal decomposition temperature of the catalyst precursor compound before supplying the reaction space with the carbon nano tube reaction gas.

Furthermore, according to the present invention, instead of performing the metal catalyst cluster generation process and the carbon nano tube growth process simultaneously, the process of generating metal catalyst clusters and the process of growing carbon nano tubes can be separated and independently performed. Therefore, a carbon nano tube having a uniform property and high purity can be produced.

According the present invention, there is provided a method for manufacturing a carbon nano tube, comprising the steps of preparing a reaction vessel including a substantially hermetic and compressible reaction space; supplying the reaction space with metal nanoparticles; supplying the reaction space with a gaseous carbon compound; and producing suspension gas with carbon nano tube products suspended therein by compressing the gaseous carbon compound in the reaction space until a temperature of the gaseous carbon compound in the reaction space reaches a temperature equal to or greater than a minimum starting temperature of the Boudouard reaction. Further, the step of supplying the reaction space with the metal nanoparticles may comprise the steps of supplying the reaction space with thermally decomposable reaction gas containing a gaseous transition metal catalyst precursor compound and generating a cluster of transition metal dissociated by compressing the reaction gas in the reaction space such that a temperature of the thermally decomposable reaction gas becomes a temperature equal to or greater than a temperature at which the gaseous transition metal catalyst precursor compound is thermally decomposed.

Furthermore, the present invention provides a method for manufacturing a carbon nano tube in which the reaction gas can be instantaneously compressed and heated at a spatially uniform temperature by using shock waves instead of using a cylinder and a piston for compressing the reaction gas.

According to the present invention, there is provided a method for manufacturing a carbon nano tube, comprising the steps of preparing a reaction vessel including a substantially hermetic reaction space; supplying the reaction space with carbon nano tube reaction gas containing a gaseous carbon compound and a gaseous transition metal catalyst precursor compound; and producing suspension gas with carbon nano tube products suspended therein by applying shock waves to the carbon nano tube reaction gas such that a temperature of the carbon nano tube reaction gas supplied to the reaction space reaches a temperature equal to or greater than a temperature at which the transition metal catalyst precursor compound is thermally decomposed and a minimum starting temperature of the Boudouard reaction. Further, the shock waves may be generated either by exploding gunpowder or by supplying the hermetic reaction space with a certain amount of high-pressure gas.

According to another aspect of the present invention, there is provided an apparatus for manufacturing a carbon nano tube, comprising a reaction vessel including a reaction gas supply port, a reaction gas discharge port and a reaction space; a first valve for opening/closing the supply port; a second valve for opening/closing the discharge port; reaction gas supply means for mixing reaction gas containing a gaseous carbon compound and/or transition metal catalyst precursor compound and supplying the mixed gas to the reaction vessel through the first valve; reaction gas compression means for producing suspension gas with carbon nano tube products suspended therein by compressing the reaction gas contained in the reaction space in a state where the first and second valves are closed such that a temperature of the reaction gas contained in the reaction vessel reaches a temperature equal to or greater than a temperature at which the transition metal catalyst precursor compound is thermally decomposed and a minimum starting temperature of the Boudouard reaction; and gas/solid separation means for separating the carbon nano tube products from the suspension gas discharged from the discharge port. Preferably, a cylinder having a closed end and an opposite open end is used as the reaction vessel, and the compression means includes a piston slidingly installed at the opposite open end and driving means for pushing the piston to compress the reaction gas contained in the reaction space. Further, the reaction gas supply means may comprise heating means for preheating the reaction gas at a temperature below the thermal decomposition temperature of the catalyst precursor compound and/or the minimum starting temperature of the Boudouard reaction before supplying the reaction space with the reaction gas.

According to a further aspect of the present invention, there is provided a carbon nano tube having a uniform property and high purity, which is produced by the manufacturing method of the present invention.

The most significant difference between a method for manufacturing a carbon nano tube according to the present invention and a method for manufacturing a carbon nano tube according to the prior art is that a heat transfer based on a temperature gradient is not be intentionally used when a temperature of reaction gas is raised to a temperature at which a metal cluster catalyst is produced or a starting temperature of Boudouard reaction at which a carbon nano tube grows in a vapor phase growth method. The heating method of the present invention employs a compression heating method by which mechanical energy can be directly transferred throughout the reaction gas, and more preferably employs an adiabatic compression heating method. This heating method due to adiabatic compression allows the reaction gas to be spatially uniformly heated. Further, in a case where it is necessary to cool the reaction gas in a process of manufacturing a carbon nano tube, an expansion cooling method by which the whole reaction gas can be simultaneously cooled using mechanical energy, and more preferably, an adiabatic cooling method may be employed. It is well known from the first law of thermodynamics that a gas temperature is increased by means of the adiabatic (meaning that there is no heat transfer to media) compression while a gas temperature is decreased by means of the adiabatic expansion. That is, according to the first law of thermodynamics, when work is adiabatically applied to gas, internal energy of the gas is increased proportionately. On the other hand, when work is adiabatically extracted from gas, internal energy is decreased proportionately.

### BRIEF DESCRIPTION OF THE DRAWINGS

FIG. 1 is a view illustrating a carbon nano tube growing a metal catalyst.

FIG. 2 is a diagram illustrating the HiPco process.

FIG. 3 is a view illustrating the principle of a method for manufacturing a carbon nano tube according to an embodiment of the present invention.

FIG. 4 is a view illustrating a method and apparatus for manufacturing a carbon nano tube according to another embodiment of the present invention.

FIG. 5 is a graph plotting a measurement of a pressure change in an end wall starting at a time when a first shock wave arrives at the end wall of a driven portion in a reactor in a case where a carbon nano tube is manufactured using the method and apparatus shown in FIG. 4.

FIG. 6 is a graph plotting a measurement of a temperature change in the end wall, which has been calculated based on the measurement of the pressure change shown in FIG. 5.

FIG. 7 is a scanning electron microscopic picture of products obtained by the method and apparatus of the present invention shown in FIG. 4.

FIG. 8 is a view illustrating a method and apparatus for manufacturing a carbon nano tube according to a further embodiment of the present invention.

FIG. 9 is a view illustrating a method and apparatus for manufacturing a carbon nano tube according to a still further embodiment of the present invention.

FIG. 10 is a view illustrating a method and apparatus for manufacturing a carbon nano tube according to a still further embodiment of the present invention.

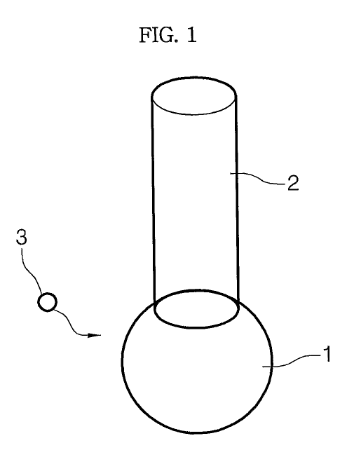

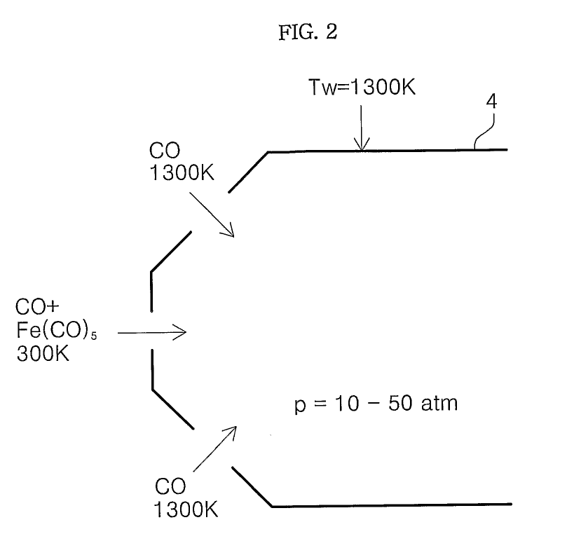

### EXPLANATION OF REFERENCE NUMERALS FOR DESIGNATING MAIN COMPONENTS IN THE DRAWINGS

| | |
|---|---|
| 10, 50, 100: Cylinders | 20, 60, 110: Pistons |
| 40: Diaphragm | 120, 130: Valves |
| 210: Pneumatic cylinder | 250: Compressed air storage tank |
| 310: Carbon monoxide storage tank | |
| 320: Evaporator | 330: Heater |
| 340, 350: Flow regulators | |

### BEST MODE FOR CARRYING OUT THE INVENTION

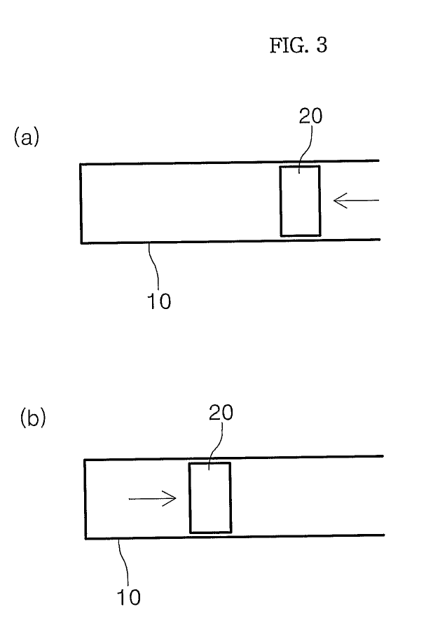

FIG. 3 illustrates a principle of manufacturing a carbon nano tube according to the present invention. A reaction vessel 10 shown in FIG. 3 (a) is filled with prefilled reactions gas (a mixed gas of Fe(CO)₅ and CO) for a carbon nano tube at a predetermined ratio. An external force is applied to move a piston 20 in a direction of an arrow shown in FIG. 3 (a) such that the reaction gas in the closed reaction vessel 10 can be compressed. This adiabatic compression is an isentropic process by which the temperature of the reaction gas is raised. According to the isentropic relationship expressed in the following well-known equation (1), the temperature of the reaction gas is raised.

T/Tₒ=(V/Vₒ)^{-(r-1)}=(p/pₒ)^{(r-1)/r}, (1)

where T, V and p are temperature, volume and pressure of the reaction gas, respectively; r is a heat insulation coefficient (in such a case, approximately 1.4), and a subscript “o” means an initial value. As the volume of the reaction gas is reduced due to the compression, the temperature of the reaction gas is raised according to the equation (1), by which a dissociation reaction (Formula (I)) in which iron pentacarbonyl is thermally decomposed occurs in the reaction gas. It is known that the thermal decomposition of the iron pentacarbonyl (Fe(CO)₅) occurs at a temperature of 250° C. or more. Iron atoms thermally decomposed at this time are combined together to produce a metal catalyst cluster (Formula (II)). If the piston is then pushed to compress the reaction gas, the temperature of the reaction gas is raised to be equal to or greater than a starting temperature of the Boudouard reaction in which a carbon nano tube grows on a surface of the metal catalyst cluster, while the pressure of the reaction gas is also suitable for the growth of carbon nano tube. At this time, the reaction in which the carbon nano tube grows on the surface of the metal catalyst cluster (Formula (III)) occurs, and thus, the carbon nano tube grows accordingly. It is known that the growth reaction of the carbon nano tube occurs at about 500° C., but a higher temperature is preferred.

The manufacturing principle of the carbon nano tube shown in FIG. 3 employs a mixed gas of Fe(CO)₅ and CO as reaction gas, but the reaction gas is not limited thereto. A combination of a proper gaseous carbon compound and a gaseous transition metal catalyst precursor compound may be utilized. As a gaseous carbon compound, methane, acetylene, ethylene, benzene, toluene and the like may be used in addition to the carbon monoxide. As a transition metal catalyst precursor compound, a metal-containing compound mainly composed of iron or cobalt is preferably used. Useful transition metal includes tungsten, molybdenum, chromium, nickel, rhodium, ruthenium, palladium, osmium, iridium, platinum, and a mixture thereof, in addition to iron and cobalt.

Further, referring to FIG. 3, the reaction vessel 10 is filled with a carbon nano tube reaction gas (a mixture of a gaseous carbon compound and a gaseous transition metal catalyst precursor compound) and the gas temperature is raised by compressing the filled gas, so that the generation of metal cluster and the growth of carbon nano tube can be performed. However, the technical spirit of the present invention is not limited thereto. As explained above, the technical spirit of the present invention is to manufacture a carbon nano tube with a uniform property and high purity by spatially uniformly heating the reaction gas through adiabatic compression. Therefore, if the reaction vessel 10 shown in FIG. 3 (a) is beforehand filled with a nano-sized metal catalyst and then injected with a carbon monoxide gas in order to compress the gas mixture using the piston, the carbon nano tube growth reaction may directly occur without passing through a thermal decomposition process of the catalyst precursor compound and the growth process of the carbon nano tube.

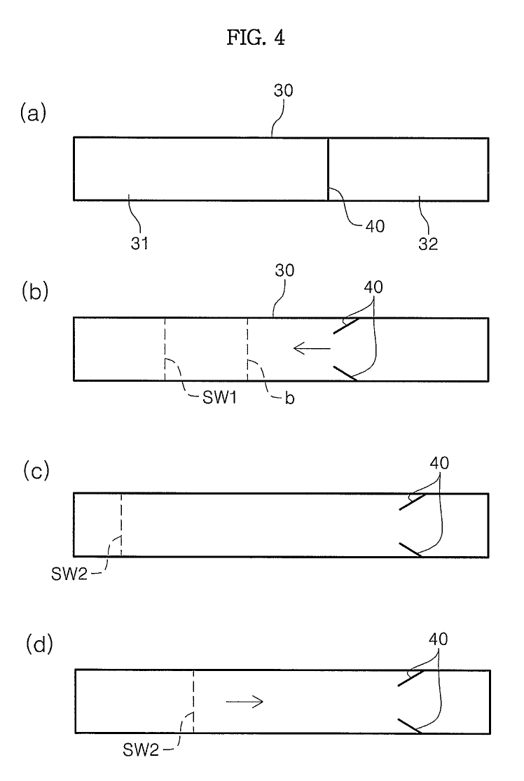

In fact, the piston shown in FIG. 3 may be replaced with a high-pressure gas. In such a case, the high-pressure gas corresponds to a virtual piston. That is, an example in which the piston is replaced with the high-pressure gas is just a shock tube. FIG. 4 shows a schematic view of an apparatus and method for manufacturing a carbon nano tube using shock wave generated in the shock tube. As shown in FIG. 4 (a), the shock tube 30 is a vessel divided into two parts, i.e. a low-pressure driven region 31 and a high-pressure driving region 32, by means of a diaphragm 40. The operating principle of the shock tube is widely described in many books such as Handbook of Shock Waves authored by Tsang W and Lifshitz A [Tsang W and Lifshitz A (2001) Handbook of Shock Waves, Academic Press, Bendor G, Igra O and Elperin T ed, 3: 107-210].

The method for manufacturing the carbon nano tube using shock waves will be explained with reference to FIG. 4. First, the low-pressure driven region 31 is filled with a carbon nano tube reaction gas (a mixed gas of gaseous Fe(CO)₅ and CO). Further, the high-pressure driving region 32 is filled with hydrogen gas serving as driving gas. Although there are a variety of divergent views as to which gas is suitable for the driving gas, hydrogen or helium is most suitable for the current purpose. As shown in FIG. 4 (b), the diaphragm 40 dividing the vessel into two regions is ruptured by means of a passive method (naturally by compression) or an active method (by mechanically striking or puncturing the diaphragm). After the diaphragm 40 is ruptured, high-pressure hydrogen in the high-pressure driving region 32 is abruptly expanded to instantaneously compress the low-pressure reaction gas in the low-pressure driven region 31 (see FIG. 4 (b)). Reference numeral “b” denotes a boundary between the reaction gas and the hydrogen for compressing the reaction gas. At this time, discontinuity of pressure and temperature referred to as a first shock wave SW1 is generated in the reaction gas. As shown in FIG. 4 (b), the first shock wave SW1 propagates toward an end wall of the low-pressure driven region 31. If the first shock wave SW1 reaches the end wall of the low-pressure driven region 31, its propagation stops. A new discontinuous shock wave SW2 is generated and then travels in an opposite direction. This shock wave is also referred to as a reflected shock wave SW2 (see FIG. 4 (c)). The reaction gas residing near the end wall of the low-pressure driven region 31, i.e. in a region between the end wall and the reflected shock wave, is increased in temperature by means of the two shock waves. This process of heating the reaction gas due to such shock waves is a kind of adiabatic process. Contrary to an isentropic process expressed by the equation (1), the shock wave phenomenon is a non-isentropic process (in which entropy is increased) and thus is depicted as a Rankine-hugoionit Relation derived from the principle of conservation of mass, momentum and energy [Ames Research Staff (1953) Equations, Tables and Charts for Compressible Flow, National Advisory committee for Aeronautics Report 1135]. The reaction gas starts to expand after a certain period of time has elapsed at a high-temperature state (see FIG. 4 (d)). The reason that the reaction gas expands is that the pressure of hydrogen serving as a driving gas is lowered than an initial high-pressure state due to the expansion. The expansion process of the driving gas satisfies the equation 1 because it is an isentropic process. The use of the shock tube in the same manner as described above will be referred to as a single pulsed shock tube.

Although either the method for compressing/expanding the reaction gas through an isentropic process to heat/cool the reaction gas using the piston as shown in FIG. 3 or the method for compressing/expanding the reaction gas through a non-isentropic process to heat/cool the reaction gas using the shock wave is employed, the pressure, temperature and concentration of the reaction gas are spatially uniform throughout the entire process. Strictly speaking, although there is discontinuity in a thin region that is contiguous to the end wall of the reaction vessel and also referred to as a boundary layer, it has very little influence on the manufacture of the carbon nano tube since this region is very thin. Therefore, the metal catalyst cluster actually generated by the thermal decomposition has a uniform (almost same) diameter. Accordingly, the carbon nano tube growing on a surface of the uniform metal catalyst cluster also has a uniform (almost same) property.

In a case where the carbon nano tube is manufactured using the shock tube, all the reactions expressed in the formula (I), (II) and (III) preferably occur when the first shock wave propagates through the reaction gas. If the reaction gas is preheated to a suitable temperature below the thermal decomposition temperature and the starting temperature of the Boudouard reaction, the foregoing can be achieved. If the reactions expressed in the formula (I), (II) and (III) occur almost simultaneously, the catalyst clusters are combined with each other at a proper size and the growth of the carbon nano tube starts at the same time. Thus, it is advantageous in the growth of the carbon nano tube. Further, it is preferred that the temperature in the reaction vessel after the reflected shock wave has propagated through the vessel not be unnecessarily high. If the temperature is unnecessarily high, the catalyst is evaporated and the growth of the carbon nano tube may thus be hindered. If the reaction gas is cooled by means of the expansion process after a long period of time sufficient to occur the reaction expressed in the formula (III), the carbon nano tube produced on the surface of the uniform metal catalyst cluster will also have a uniform property.

To verify the technical spirit of the present invention, the shock wave test illustrated in FIG. 4 (a) to (d) has been executed. The objective of this test is to show that the metal catalyst cluster required in producing the carbon nano tube can be manufactured through the adiabatic compression heating and adiabatic expansion cooling. Several variables in this test will be summarized in the following table 1.

TABLE 1

| | |
|---|---|
| Diameter of low-pressure driven region | 47.5 mm |
| Length of low-pressure driven region | 3 m |
| Diameter of high-pressure driving region | 68 mm |
| Length of high-pressure driving region | 2.4 m |
| Driving gas | Hydrogen |
| Reaction gas | 1.5% Fe(CO)₅ + |
| | 98.5% CO |
| Initial pressure of reaction gas | 550 torr |
| Pressure of driving gas | 37 atm |
| Shock wave speed | 1200 m/s |
| Pressure of reflected shock wave (at end wall) | 60 atm |
| Temperature of reflected shock wave (at end wall) | 1500 K |
| Duration of reflected shock wave conditions | 0.5 msec |

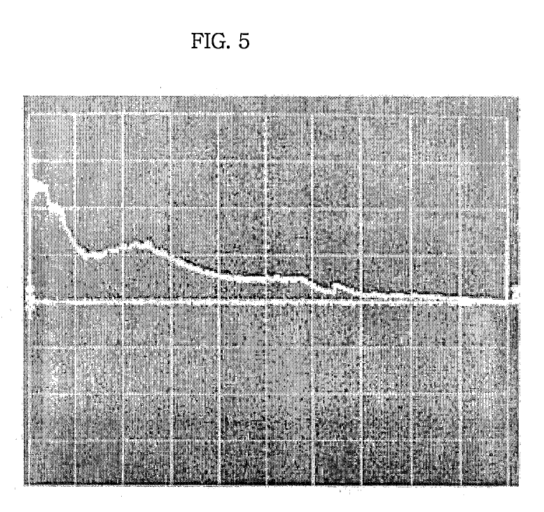

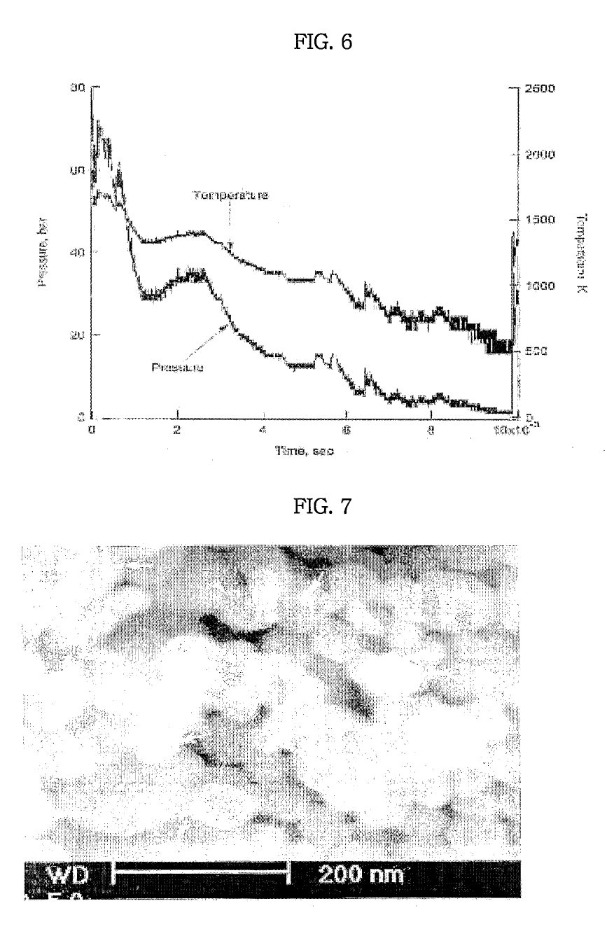

In a case where a shock tube test is performed under the conditions listed in the table 1, the pressure of the reaction gas measured at the end wall in the low-pressure driven region according to time is plotted in the graph shown in FIG. 5. The temperature of the reaction gas calculated at this time using the equation (1) is plotted in the graph shown in FIG. 6.

After the dynamic process has been completed in the shock tube, the shock tube is opened to collect powder materials adhering to the end wall of the low-pressure driven region. Then, the collected powder materials were inspected using a scanning electron microscope (SEM). FIG. 7 shows an SEM image of the products obtained from this test. Spherical products with a diameter of 20 to 100 nanometers, which are designated by arrows in FIG. 7, are metal catalyst clusters. A small protrusion on a surface of the catalyst shown at a position designated by the arrow is a carbon nano tube in its initial growth state.

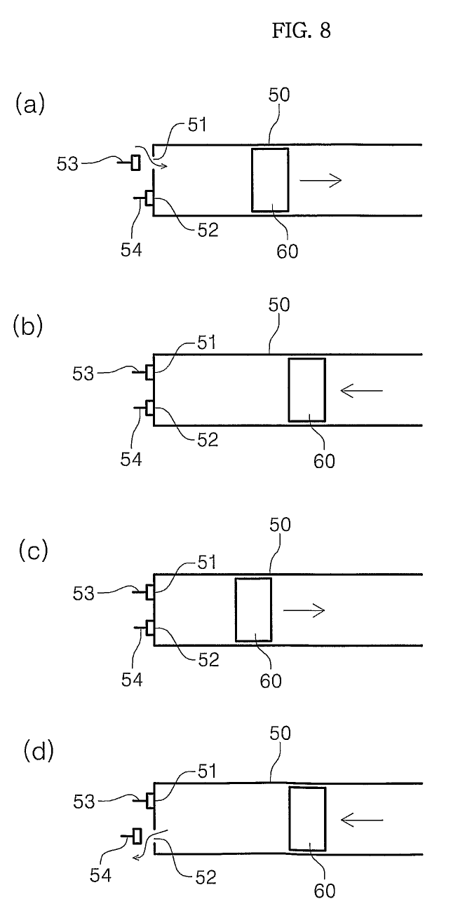

FIG. 8 is a schematic view of the apparatus and method for producing the carbon nano tubes in large quantities according to the present invention. The illustrated apparatus for mass-producing the carbon nano tubes has a structure similar to a four-stroke internal combustion engine.

As shown in FIG. 8 (a), the apparatus for mass-producing the carbon nano tubes according to the embodiment of the present invention comprises a cylinder 50 having an open end and an opposite closed end, a piston 60 reciprocating through the open end of the cylinder 50 to perform the adiabatic compression and expansion of the reaction gas, intake and exhaust ports 51 and 52 formed on the closed side of the cylinder, and valves 53 and 54 for opening/closing the intake and exhaust ports 51 and 52, respectively.

A process of manufacturing a carbon nano tube using the apparatus so configured will be explained. Referring to FIG. 8 (a), in a state where the intake valve 53 is opened and the exhaust valve 54 is closed, the piston 60 is moved rearward to inhale the reaction gas of the carbon nano tube (mixed gas of Fe(CO)₅ and CO) into the cylinder 50. Next, the intake valve 53 is closed and the piston 60 is moved forward to compress the reaction gas in the cylinder 50 (see FIG. 8 (b)). The compressed reaction gas is increased in its temperature, and the iron pentacarbonyl is thermally decomposed to generate the metal cluster (refer to Formula (I) and (II)). If the reaction gas is further compressed and its temperature reaches a temperature above the starting temperature of the Boudouard reaction, carbon monoxide molecules start to collide against a surface of the metal cluster and a carbon nano tube starts to grow due to the occurrence of the reaction expressed in formula (III) (referred to formula (III)). At this time, the compression is stopped. After the period of time necessary to the growth of the carbon nano tube has elapsed, the piston 60 is again moved rearward to perform the compression cooling of the reaction gas (see FIG. 8 (c)). In a case where the carbon nano tube growth is hindered due to the evaporation of the metal cluster catalyst resulting from the unduly increased temperature of the compressed reaction gas or the cooling/heating is needed to control the density/size of the metal cluster to be produced even while the carbon nano tube grows, the reaction gas may be kept at a constant temperature by controlling the forward or rearward movement of the piston 60. Then, the exhaust valve 54 is opened and the piston 60 is moved forward to discharge gas with carbon nano tube products suspended therein through the exhaust port. Although it is not shown herein, the carbon nano tube products are separated from the discharged gas with the carbon nano tube products, using a separating device. Accordingly, the carbon nano tubes with a uniform property can be successively mass-produced by performing the process illustrated in FIG. 8 (a) to (d).

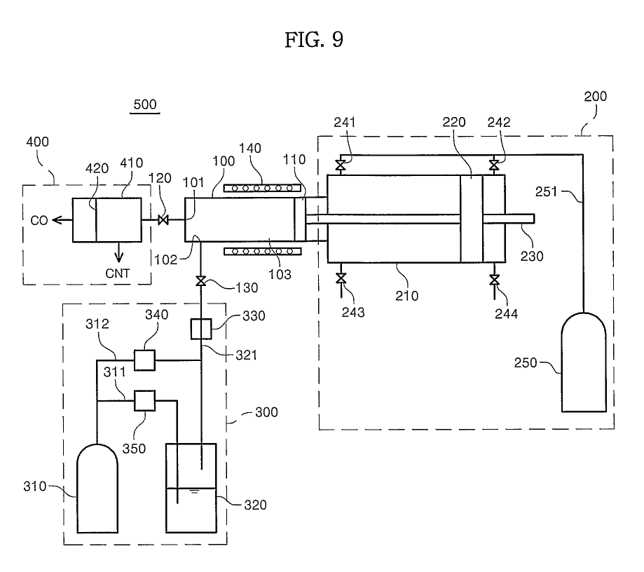

FIG. 9 illustrates an apparatus and method for manufacturing a carbon nano tube according to another embodiment of the present invention. Referring to FIG. 9, an apparatus 500 for manufacturing a carbon nano tube comprises a reaction vessel 100 including a reaction gas supply port 102, a reaction gas discharge port 101 and a reaction space 103; a first valve 130 for opening/closing the supply port 102; a second valve 120 for opening/closing the discharge port 101; reaction gas supply means 300 for mixing reaction gas containing a gaseous carbon compound and/or transition metal catalyst precursor compound and supplying the mixed gas to the reaction vessel 100 through the first valve 130; reaction gas compression means 200 for compressing the reaction gas contained in the reaction space in a state where both the first and second valves 130 and 120 are closed such that the temperature of the reaction gas contained in the reaction vessel 100 becomes a temperature equal to or greater than a minimum starting temperature of the Boudouard reaction and a temperature at which the transition metal catalyst precursor compound is thermally decomposed, thereby producing gas with carbon nano tube products suspended therein; and gas/solid separation means 400 for separating the carbon nano tube products from the suspended carbon nano tube products containing gas discharged from the discharge port 101. The gas/solid separation means 400 includes a chamber 410, and a filtration membrane 420 installed within the chamber 410.

In this embodiment of the present invention, the reaction vessel 100 is a cylinder having a closed end and an opposite open end. Further, the compression means includes a piston 110 slidingly installed at the opposite open end, and a pneumatic cylinder 210 for pushing the piston to compress the reaction gas contained in the reaction space. An end of a rod 230 of the pneumatic cylinder 210 is connected to the piston 110 used for compressing the reaction gas. A piston 220 of the pneumatic cylinder 210 according to this embodiment has a diameter greater than that of the piston 110 for compressing the reaction gas, such that it can provide a compression force capable of compressing the reaction gas at a sufficient rate. Supply valves 241 and 242 through which compressed air is supplied to move forward and rearward the rod 230 are installed at opposite ends of the pneumatic cylinder 210. Further, drain valves 243 and 244 through which the air is discharged when the rod 230 moves forward and rearward are installed at the opposite ends of the pneumatic cylinder 210. Reference numeral 250, which has not yet explained, designates a source for supplying high-pressure compressed air.

The apparatus 500 of the embodiment employs a pneumatic cylinder as compression means. However, a hydraulic cylinder may be used as compression means, and a connecting rod and crankshaft may be used for allowing the piston to continuously perform the compression and expansion process, if desired.

The reaction gas supply means 300 includes a tank 310 in which carbon monoxide is stored, and an evaporator 320 in which an organic metal compound such as iron pentacarbonyl Fe(CO)₅ is dissolved. The carbon monoxide stored in the tank 310 is supplied to the reaction space via pipes 312 and 321. Further, the carbon monoxide stored in the tank 310 is also supplied to the evaporator 320 via a pipe 311 such that it is used for evaporating the liquid Fe(CO)₅ and supplying the reaction space with the evaporated Fe(CO)₅. The gaseous Fe(CO)₅ evaporated in the evaporator is supplied to the reaction space 103 via the pipe 321. Reference numerals 340 and 350, which have not yet explained, designate flow regulators used to adjust a ratio of the carbon monoxide and iron pentacarbonyl supplied to the reaction space 103. In this embodiment, the carbon monoxide has been used as a source gas for evaporating the Fe(CO)₅ dissolved in the evaporator 320. However, inert gas such as argon may be used as a source gas and the gaseous carbon compound may also be provided directly to the reaction space.

The apparatus 500 of the embodiment includes heating means 330 which is installed to the pipe 321 to preheat the reaction gas at a temperature below the thermal decomposition temperature of the catalyst precursor compound and the minimum starting temperature of the Boudouard reaction before supplying the reaction space 103 with the reaction gas. A heater may be used as the heating means 330. In addition, the apparatus of the embodiment further includes a heater 140 installed to preheat the reaction gas supplied to the reaction vessel 100.

The process for manufacturing a carbon nano tube will be described in connection with the apparatus 500 of the embodiment shown in FIG. 9. First, in a state where the valve 130 is opened and the valve 120 is closed, the piston 110 is moved rearward and the flow regulator 350 connected to the carbon monoxide storage tank 310 is simultaneously adjusted to evaporate Fe(CO)₅ stored in the evaporator 320, so that the evaporated gas can be supplied to the reaction space 103 via the pipe 321. At the same time, the flow regulator 340 is adjusted to supply the carbon monoxide stored in the tank 310 to the reaction space via the pipe 321. At this time, the reaction gas is preheated to a proper temperature using the heater 330 installed to the pipe 321. Then, the compressed air stored in the compressed air storage tank 250 is supplied to the pneumatic cylinder 210 to move the piston 110 forward, so that the reaction gas contained in the reaction space 103 can be heated through compression. At this time, both the valves 120 and 130 are closed. The temperature of the compressed reaction gas is raised and the reactions expressed in the formula (I) to (III) are made, thereby generating a carbon nano tube. After the lapse of a period of time sufficient to generate the carbon nano tube, the piston 110 is moved rearward to cool the reaction gasses through adiabatic expansion. Thereafter, the piston 110 is moved forward to discharge the gas with carbon nano tube products suspended therein through the discharge port 101. The discharged gas with the carbon nano tube products suspended therein is separated into a solid component including the carbon nano tube products and a gaseous component including carbon monoxide by the filtration membrane 420 installed in the chamber 410. The carbon monoxide that has passed through the filtration membrane may circulate to be used again.

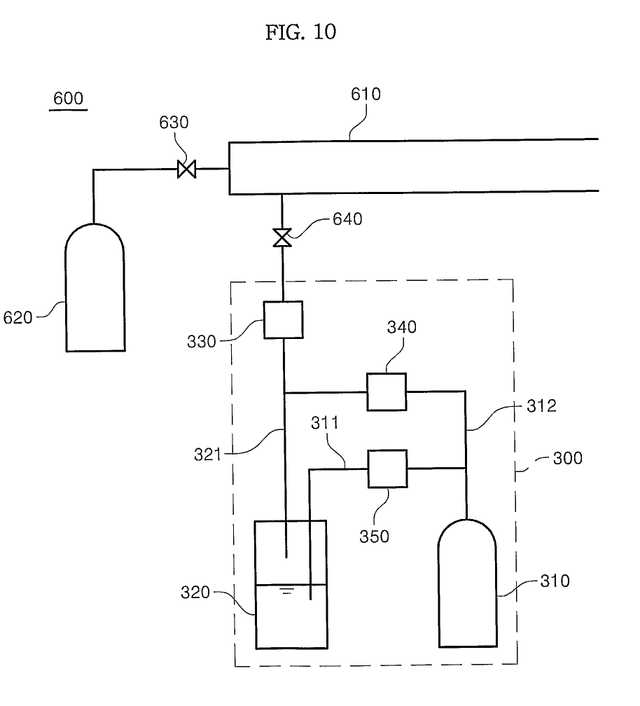

FIG. 10 is a schematic view illustrating a method and apparatus for manufacturing a carbon nano tube according to a still further embodiment of the present invention. The apparatus 600 of the embodiment shown in FIG. 10 comprises a cylinder 610 having an open end and an opposite closed end, reaction gas supply means 300 for mixing reaction gas containing a gaseous carbon compound and/or transition metal catalyst precursor compound and supplying the mixed gas to the cylinder 610, and shock wave generating means installed at one side of the cylinder 610 to apply shock waves to the reaction gas such that the temperature of the reaction gas contained in the cylinder 610 reaches a temperature equal to or greater than the minimum starting temperature of the Boudouard reaction and the temperature at which the transition metal catalyst precursor compound is thermally decomposed. The reaction gas supply means in this embodiment is identical to that shown in FIG. 9. In this embodiment, the shock wave generating means employs a high-pressure source 620 that is installed at one end of the cylinder 610 to supply a high-pressure driving gas into the cylinder 610 with the reaction gas contained therein. However, shock waves may be generated by installing gunpowder in the cylinder and exploding the gunpowder. A description of the mechanism in which the reaction gas is compressed and heated by means of shock waves generated by the high-pressure gas or the gunpowder explosion within the cylinder is identical to that of FIG. 4, except that no second shock wave is generated due to the absence of an end wall.

In this embodiment, the other end of the cylinder 610 is opened. If the other end is closed and the high-pressure driving gas is supplied, the apparatus becomes an apparatus conceptually identical to the shock tube shown in FIG. 4.

It is intended that the embodiments of the present invention described above and illustrated in the drawings should not be construed as limiting the technical spirit of the present invention. The scope of the present invention is not limited to the embodiments but should be defined only by the appended claims. It is apparent to those skilled in the art that various changes and modifications can be made thereto without departing from the technical spirit of the present invention. Therefore, various changes and modifications fall within the scope of the present invention so far as they are obvious to those skilled in the art.

### INDUSTRIAL APPLICABILITY

According to the present invention, there is provided a method and apparatus for manufacturing a carbon nano tube, wherein a carbon nano tube reaction gas containing a gaseous carbon compound and a gaseous transition metal catalyst precursor compound is uniformly heated though compression. The carbon nano tube produced by the method and apparatus of the present invention has a uniform property since it grows on the surface of a metal cluster with a uniform size produced in an atmosphere spatially uniformly heated.

Further, according to the present invention, there is provided a method and apparatus for manufacturing a carbon nano tube, by which a carbon nano tube with a uniform property can be mass-produced. The present invention provides an apparatus similar to a four-stroke internal combustion engine having a cylinder and a piston. The apparatus can mass-produce a carbon nano tube with a uniform property by repeatedly performing a cycle in which reaction gas is sucked, compressed, expanded and discharged.

1. A method for manufacturing a carbon nano tube, comprising the steps of:
preparing a reaction vessel including a substantially hermetic and compressible reaction space;
supplying the reaction space with carbon nano tube reaction gas containing a gaseous carbon compound and a gaseous transition metal catalyst precursor compound; and
producing suspension gas with carbon nano tube products suspended therein by compressing the reaction gas in the reaction space until a temperature of the carbon nano tube reaction gas supplied to the reaction space reaches a temperature equal to or greater than a temperature at which the transition metal catalyst precursor compound is thermally decomposed and a minimum starting temperature of the Boudouard reaction.

2. The method as claimed in claim 1, further comprising the step of preheating the carbon nano tube reaction gas at a temperature below the thermal decomposition temperature of the catalyst precursor compound before supplying the reaction space with the carbon nano tube reaction gas.

3. The method as claimed in claim 2, wherein the carbon nano tube reaction gas further comprising a gaseous metal-bearing compound for promoting cluster formation of thermally decomposed transition metal.

4. The method as claimed in claim 3, wherein the step of producing the suspension gas with carbon nano tube products suspended therein further comprises the step of maintaining the temperature of the carbon nano tube reaction gas within a predetermined temperature range equal to or greater than the Boudouard reaction temperature by compressing or expanding the reaction gas in the reaction space.

5. The method as claimed in claim 1, wherein the carbon compound is carbon monoxide, and the catalyst precursor compound is a compound containing a metal selected from a group consisting of tungsten, molybdenum, chromium, iron, nickel, cobalt, rhodium, ruthenium, palladium, osmium, iridium, platinum, and a mixture thereof.

6. The method as claimed in claim 5, wherein the metal-containing compound is metal carbonyl.

7. The method as claimed in claim 6, wherein the metal carbonyl is Fe(CO)₅, Co(CO)₆ or a mixture thereof.

8. The method as claimed in claim 1, wherein the reaction vessel is substantially heat-insulated to prevent heat transfer to and from the outside.

9. A method for manufacturing a carbon nano tube, comprising the steps of:
preparing a reaction vessel including a substantially hermetic and compressible reaction space;
supplying the reaction space with metal nanoparticles;
supplying the reaction space with a gaseous carbon compound; and
producing suspension gas with carbon nano tube products suspended therein by compressing the gaseous carbon compound in the reaction space until a temperature of the gaseous carbon compound in the reaction space reaches a temperature equal to or greater than a minimum starting temperature of the Boudouard reaction.

10. The method as claimed in claim 9, wherein the step of supplying the reaction space with the metal nanoparticles comprises the steps of supplying the reaction space with thermally decomposable reaction gas containing a gaseous transition metal catalyst precursor compound and generating clusters of transition metal dissociated by compressing the thermally decomposable reaction gas in the reaction space such that a temperature of the thermally decomposable reaction gas becomes a temperature equal to or greater than a temperature at which the gaseous transition metal catalyst precursor compound is thermally decomposed.

11. The method as claimed in claim 10, further comprising the step of preheating the thermally decomposable reaction gas at a temperature below the thermal decomposition temperature of the gaseous transition metal catalyst precursor compound before supplying the reaction space with the thermally decomposable reaction gas containing the gaseous transition metal catalyst precursor compound.

12. The method as claimed in claim 9, further comprising the step of preheating the gaseous carbon compound at a temperature below the minimum starting temperature of the Boudouard reaction before supplying the reaction space with the gaseous carbon compound.

13. The method as claimed in claim 12, wherein the carbon compound is carbon monoxide, and the catalyst precursor compound is a compound containing a metal selected from a group consisting of tungsten, molybdenum, chromium, iron, nickel, cobalt, rhodium, ruthenium, palladium, osmium, iridium, platinum, and a mixture thereof.

14. The method as claimed in claim 13, wherein the metal-containing compound is metal carbonyl.

15. The method as claimed in claim 14, wherein the metal carbonyl is Fe(CO)₅, Co(CO)₆ or a mixture thereof.

16. A method for manufacturing a carbon nano tube, comprising the steps of:
preparing a reaction vessel including a substantially hermetic reaction space;
supplying the reaction space with carbon nano tube reaction gas containing a gaseous carbon compound and a gaseous transition metal catalyst precursor compound; and
producing suspension gas with carbon nano tube products suspended therein by applying shock waves to the carbon nano tube reaction gas such that a temperature of the carbon nano tube reaction gas supplied to the reaction space reaches a temperature equal to or greater than a temperature at which the transition metal catalyst precursor compound is thermally decomposed and a minimum starting temperature of the Boudouard reaction.

17. The method as claimed in claim 16, wherein the shock waves are generated by exploding gunpowder.

18. The method as claimed as claimed in claim 16, wherein the shock waves are generated by supplying the hermetic reaction space with a certain amount of high-pressure gas.

19. The method as claimed in claim 17, further comprising the step of preheating the carbon nano tube reaction gas at a temperature below the thermal decomposition temperature of the catalyst precursor compound before supplying the reaction space with the carbon nano tube reaction gas.

20. The method as claimed in claim 19, wherein the carbon nano tube reaction gas further contains a gaseous metal-containing compound for promoting cluster formation of thermally decomposed transition metal.

21. The method as claimed in claim 19, wherein the carbon compound is carbon monoxide, and the catalyst precursor compound is a compound containing a metal selected from a group consisting of tungsten, molybdenum, chromium, iron, nickel, cobalt, rhodium, ruthenium, palladium, osmium, iridium, platinum, and a mixture thereof.

22. The method as claimed in claim 21, wherein the metal-containing compound is metal carbonyl.

23. The method as claimed in claim 22, wherein the metal carbonyl is Fe(CO)₅, Co(CO)₆ or a mixture thereof.

24. A method for manufacturing a carbon nano tube, comprising the steps of:
preparing a reaction vessel including a substantially hermetic and compressible reaction space;
supplying the reaction space with metal nanoparticles;
supplying the reaction space with a gaseous carbon compound; and
producing suspension gas with carbon nano tube products suspended therein by applying shock waves to the reaction space until a temperature of the gaseous carbon compound in the reaction space reaches a temperature equal to or greater than a minimum starting temperature of the Boudouard reaction.

25. The method as claimed in claim 24, wherein the step of supplying the reaction space with the metal nanoparticles comprises the steps of supplying the reaction space with thermally decomposable reaction gas containing a gaseous transition metal catalyst precursor compound, and generating clusters of transition metal dissociated by compressing the thermally decomposable reaction gas in the reaction space such that a temperature of the thermally decomposable reaction gas becomes a temperature equal to or greater than a temperature at which the gaseous transition metal catalyst precursor compound is thermally decomposed.

26. The method as claimed in claim 25, further comprising the step of preheating the thermally decomposable reaction gas at a temperature below the thermal decomposition temperature of the gaseous transition metal catalyst precursor compound before supplying the reaction space with the thermally decomposable reaction gas containing the gaseous transition metal catalyst precursor compound.

27. The method as claimed in claim 24, further comprising the step of preheating the gaseous carbon compound at a temperature below the minimum starting temperature of the Boudouard reaction before supplying the reaction space with the gaseous carbon compound.

28. The method as claimed in claim 27, wherein the carbon compound is carbon monoxide, and the catalyst precursor compound is a compound containing a metal selected from a group consisting of tungsten, molybdenum, chromium, iron, nickel, cobalt, rhodium, ruthenium, palladium, osmium, iridium, platinum, and a mixture thereof.

29. The method as claimed in claim 28, wherein the metal-containing compound is metal carbonyl.

30. The method as claimed in claim 29, wherein the metal carbonyl is Fe(CO)₅, Co(CO)₆ or a mixture thereof.

31. An apparatus for manufacturing a carbon nano tube, comprising:
a reaction vessel including a reaction gas supply port, a reaction gas discharge port and a reaction space;
a first valve for opening/closing the supply port;
a second valve for opening/closing the discharge port;
reaction gas supply means for mixing reaction gas containing a gaseous carbon compound and/or transition metal catalyst precursor compound and supplying the mixed gas to the reaction vessel through the first valve;
reaction gas compression means for producing suspension gas with carbon nano tube products suspended therein by compressing the reaction gas contained in the reaction space in a state where the first and second valves are closed such that a temperature of the reaction gas contained in the reaction vessel reaches a temperature equal to or greater than a temperature at which the transition metal catalyst precursor compound is thermally decomposed and a minimum starting temperature of the Boudouard reaction; and
gas/solid separation means for separating the carbon nano tube products from the suspension gas discharged from the discharge port.

32. The apparatus as claimed in claim 31, wherein the reaction vessel is shaped as a cylinder having a closed end and an opposite open end, and the compression means includes a piston slidingly installed at the opposite open end and driving means for pushing the piston to compress the reaction gas contained in the reaction space.

33. The apparatus as claimed in claim 31, wherein the reaction gas supply means further comprises heating means for preheating the reaction gas at a temperature below the thermal decomposition temperature of the catalyst precursor compound and/or the minimum starting temperature of the Boudouard reaction before supplying the reaction space with the reaction gas.

34. The apparatus as claimed in claim 31, further comprising heating means for heating the reaction vessel.

35. The apparatus as claimed in claim 32, wherein the driving means is capable of compressing or expanding the reaction gas contained in the reaction space to maintain the temperature of the reaction gas within a predetermined temperature range equal to or greater than the Boudouard reaction temperature.

36. The apparatus as claimed in claim 34, further comprising heat-insulating means for substantially preventing heat transfer between the reaction vessel and the outside.

37. The apparatus as claimed in claim 32, wherein the driving means includes a piston rod fixed to an end of the piston and pneumatic or hydraulic cylinder for pushing the piston rod.

38. The apparatus as claimed in claim 32, wherein the driving means includes a connecting rod fixed to an end of the piston and a crankshaft connected to another end of the connecting rod.

39. The apparatus as claimed in claim 31, wherein the compression means is shock wave generating means which is installed to the reaction vessel to apply shock waves to the carbon nano tube reaction gas such that the temperature of the reaction gas contained in the reaction vessel reaches a temperature equal to or greater than the minimum starting temperature of the Boudouard reaction and a temperature at which the transition metal catalyst precursor compound is thermally decomposed.

40. The apparatus as claimed in claim 39, wherein the shock wave generating means is gunpowder which is installed within the reaction space to generate shock waves by exploding the gunpowder.

41. The apparatus as claimed in claim 39, wherein the reaction vessel is shaped as a cylinder having a closed end and an opposite open end, and the shock wave generating means is high-pressure gas supply means which is installed to the opposite open end of the reaction vessel to allow the reaction space to be substantially hermetic and to supply high-pressure driving gas into the reaction space.

42. The apparatus as claimed in claim 39, wherein the reaction vessel is shaped as a cylinder having a closed end and an opposite open end, and the shock wave generating means is high-pressure gas supply means which is installed to the closed end of the reaction vessel to supply high-pressure driving gas into the reaction space.

43. The apparatus as claimed in claim 41, wherein the driving gas is hydrogen.

44. A carbon nano tube produced by a method for manufacturing a carbon nano tube according to claim 1.
